(19) United States
(12) Patent Application Publication
(10) Pub. No.: US 2015/0235415 A1
(43) Pub. Date: Aug. 20, 2015

(54) WAFER TEST DATA ANALYSIS METHOD

(71) Applicants: KWUN JONG CHEN, HSINCHU COUNTY 310 (TW); SIGNALITY SYSTEM ENGINEERING CO., LTD., HSINCHU COUNTY 310 (TW); HUNG WU MACHINE CO., LTD., HSIN CHU CITY (TW)

(72) Inventor: KWUN JONG CHEN, HSINCHU COUNTY 310 (TW)

(21) Appl. No.: 14/486,002

(22) Filed: Sep. 15, 2014

(30) Foreign Application Priority Data
Feb. 19, 2014 (TW) 103105453

(51) Int. Cl. G06T 17/10; G06T 15/10

(52) U.S. Cl. CPC G06T 17/10; G06T 15/10

(57) ABSTRACT

A wafer test data analysis method. A test wafer is divided into a plurality of test chips. Each of the test chips is tested for electrical property and captured data under various parameters. A specific parameter is sorted from the parameters according to a requirement of an analysis result. Defining a three-dimensional space coordinate, the three-dimensional space coordinate has a plurality of coordinate points (X, Y, Z) to create a three-dimensional parameter location map and a three-dimensional bin-bar map.

### BACKGROUND OF THE INVENTION

1. Field of the Invention

The present invention relates to a semiconductor manufacturing process, and more particular to a wafer test data analysis method.

2. Description of the Prior Art

In the process of wafer test, the yield of a device under test (DUT) is not only influenced by individual problems of the process but also influenced by the other factors such as problems of testing machine. The problems of testing machine include improper correction of a test probe of the testing machine or improper testing parameter of the program of the testing machine, which would influence the yield of the device under test. In case the quality control process cannot analyze failure problem of the device under test caused by the individual problems of the process or the testing machine, the failure problem of the device under test cannot be solved. Moreover, the testing information of pass device under test cannot be traced. If the final product needs to be corrected, the correlated data is unavailable.

### SUMMARY OF THE INVENTION

An object of the present invention is to provide a wafer test data analysis method to generate a three-dimensional parameter location map and a three-dimensional bin-bar map for subsequent analysis and application.

To achieve the above and other objects, a wafer test data analysis method, comprising the steps of:
obtaining data: dividing a test wafer into a plurality of test chips, each of the test chips being tested for electrical property and captured data under various parameters;
sorting analyzing parameter: a specific parameter being sorted from the various parameters according to a requirement of an analysis result;
drawing three-dimensional parameter location map and three-dimensional bin-bar map: defining a three-dimensional space coordinate comprising an X-coordinate axis represented a first parameter, a Y-coordinate axis represented a second parameter, and a Z-coordinate axis represented a third parameter, the three-dimensional space coordinate having a plurality of coordinate points (X, Y, Z) to create a three-dimensional parameter location map and a three-dimensional bin-bar map.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a three-dimensional parameter location map with respect to the frequency from the electrical property test of each test chip;

FIG. 2 is the three-dimensional parameter location map after process correction;

FIG. 3 is another three-dimensional parameter location map with respect to the electric current from the electrical property test of each test chip;

FIG. 4 is another three-dimensional parameter location map with respect to the accumulative count of failed test chips at the same coordinate point (X, Y);

FIG. 5 is the other three-dimensional parameter location map with respect to the accumulative count of pass test chips at the same coordinate point (X, Y);

FIG. 6 is a three-dimensional bin-bar map for a plurality of wafers under a specific grade;

FIG. 7 is another three-dimensional bin-bar map for a plurality of wafers under a plurality of specific grades; and

FIG. 8 is the other three-dimensional bin-bar map for a plurality of wafers under a plurality of specific grades and classification groups.

### DETAILED DESCRIPTION OF THE PREFERRED EMBODIMENTS

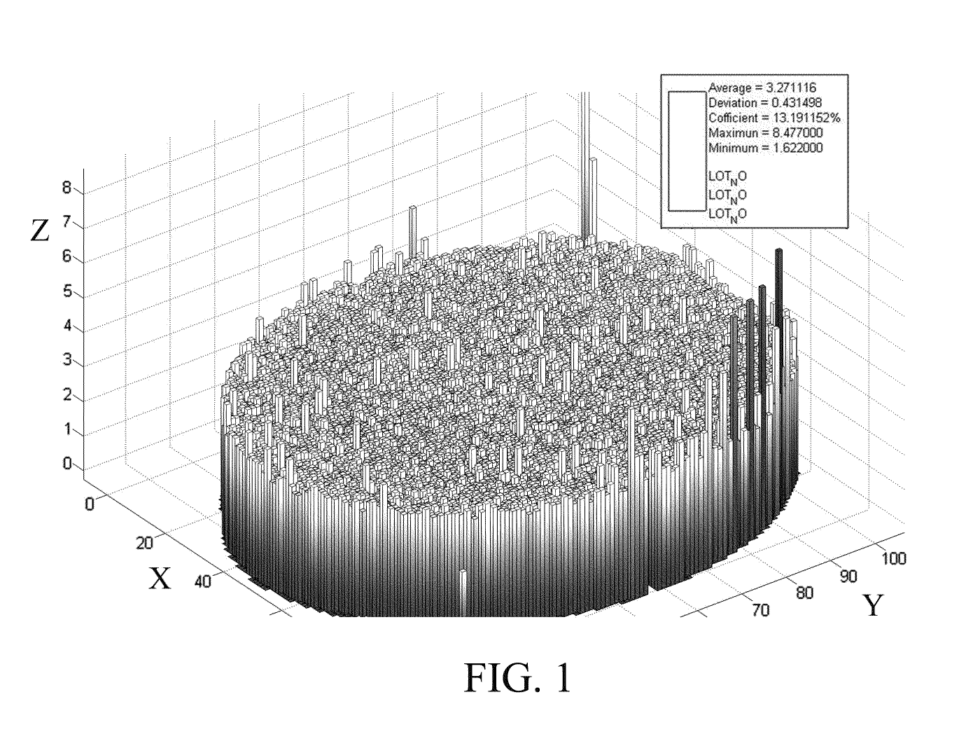

Referring to FIGS. 1-8, a wafer test data analysis method in accordance with a preferred embodiment of the present invention comprises the steps of:

Obtaining data: dividing a test wafer into a plurality of test chips; each of the test chips is tested for electrical property and captured data under various parameters.

Sorting analyzing parameter: a specific parameter is sorted from the various parameters according to a requirement of an analysis result.

Drawing three-dimensional parameter location map and three-dimensional bin-bar map: defining a three-dimensional space coordinate which comprises an X-coordinate axis represented a first parameter, a Y-coordinate axis represented a second parameter, and a Z-coordinate axis represented a third parameter. The three-dimensional space coordinate has a plurality of coordinate points (X, Y, Z) to create a three-dimensional parameter location map and a three-dimensional bin-bar map.

In the preferred embodiment, the three-dimensional space coordinate is transformed by a computer apparatus depending on positions of the test chips within the test wafer and the data of the specific parameter. Specifically, the X and Y-coordinate axes regard as an abscissa and the Z-coordinate axis regards as an ordinate. The abscissa defines a coordinate point (X, Y) of each test chip and the ordinate defines a coordinate point (Z) for the data of the specific parameter. The test chips accord with the coordinate points (X, Y, Z) within the three-dimensional space coordinate to create the three-dimensional parameter location map and the three-dimensional bin-bar map.

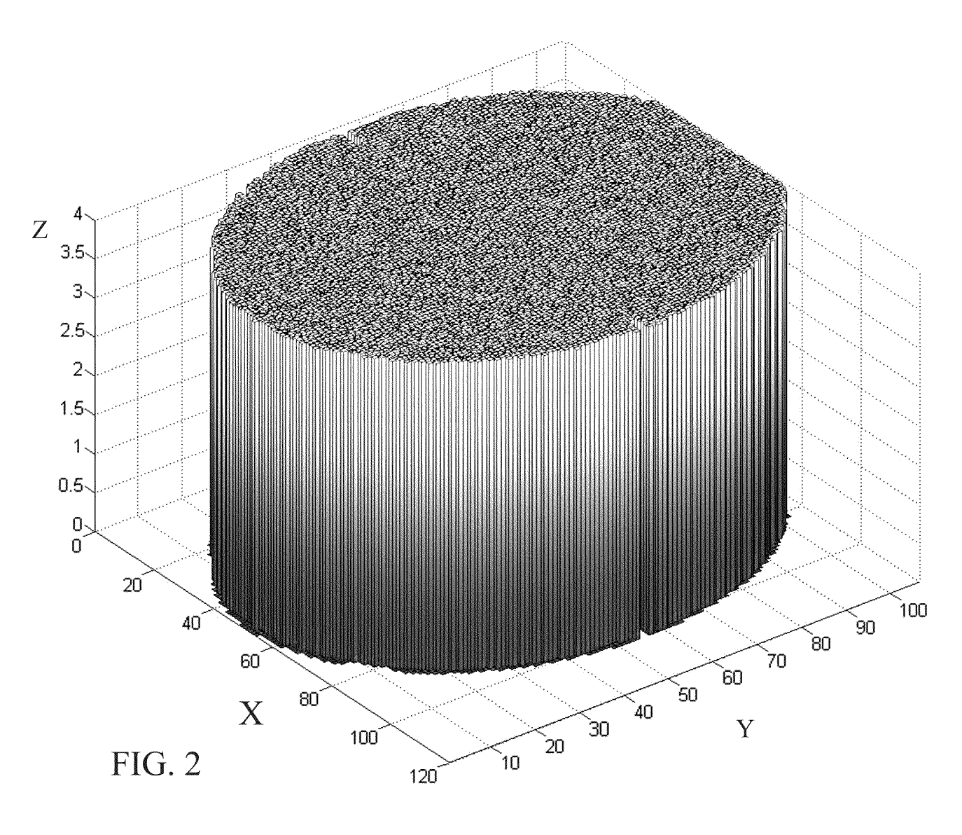

As shown in FIG. 1, one three-dimensional parameter location map is generated by the aforementioned wafer test data analysis method with respect to single one wafer. Each test chip of the test wafer is defined with a coordinate point (X, Y) within the three-dimensional parameter location map, wherein the parameter is defined with respect to the frequency from the electrical property test of each test chip, so that the data of the frequency from the electrical property test of each test chip regards as the respective coordinate point (Z). Referring to the three-dimensional parameter location map in FIG. 1, it is observed that variances appeared in the frequency generated from the electrical property test of each test chip, which needs to be corrected in the process. The three-dimensional parameter location map in FIG. 2 shows the data of the frequency from the electrical property test of each test chip after process correction. It is observed that the frequency of the electrical property of each test chip is closed with each other.

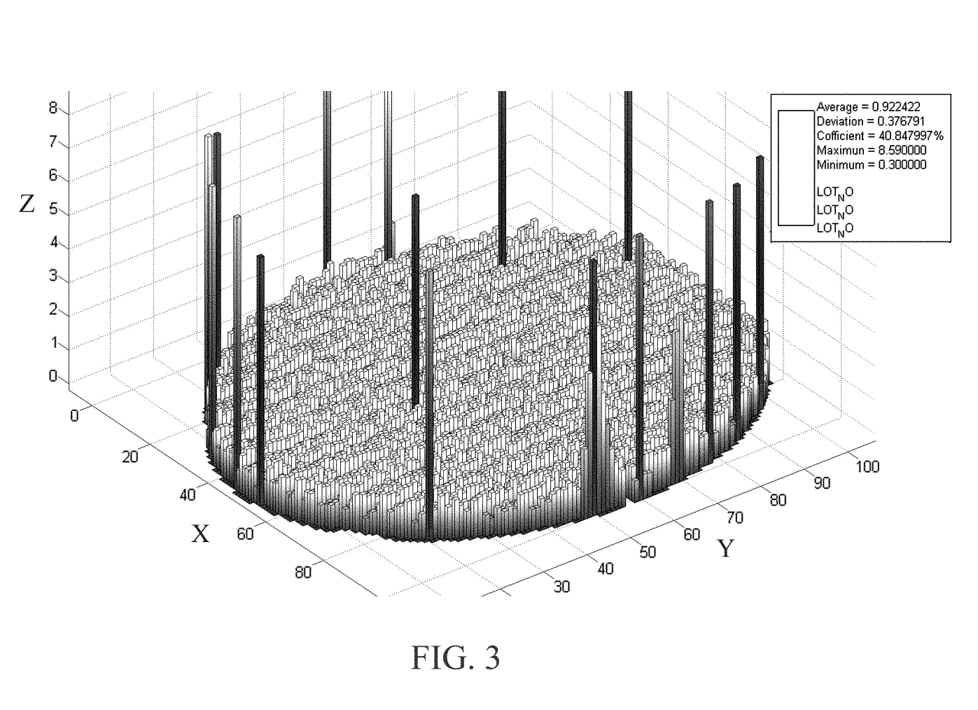

As shown in FIG. 3, another three-dimensional parameter location map is generated by the aforementioned wafer test data analysis method with respect to single one wafer. Each test chip of the test wafer is defined with a coordinate point (X, Y) within the three-dimensional parameter location map, wherein the parameter is defined with respect to the electric current from the electrical property test of each test chip, so that the data of the electric current from the electrical property test of each test chip regards as the respective coordinate point (Z).

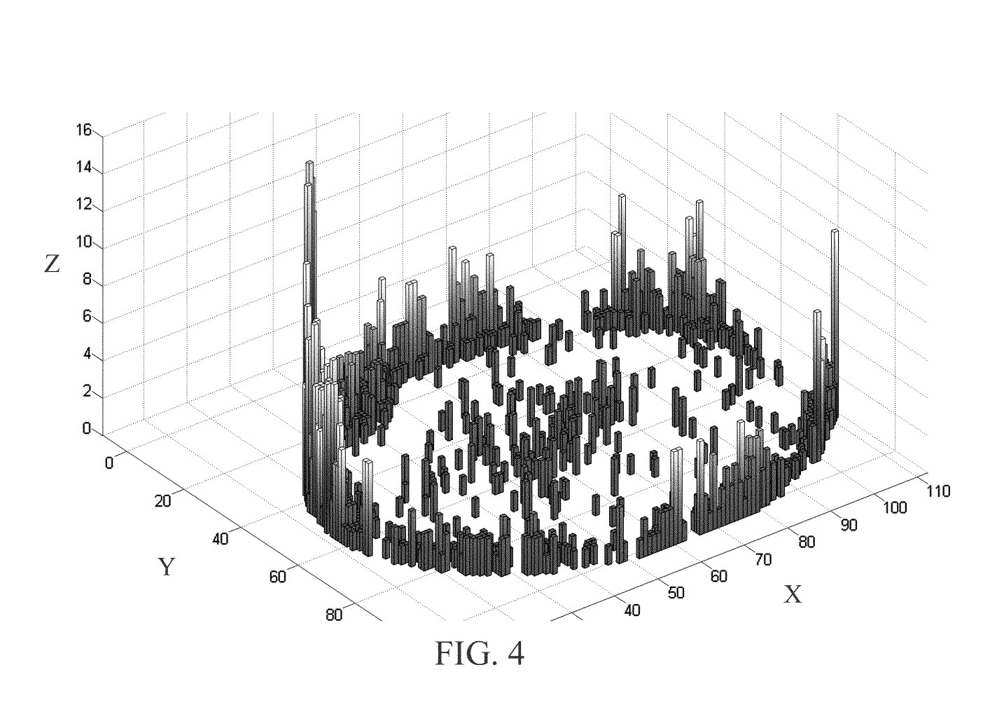

As shown in FIG. 4, another three-dimensional parameter location map is generated by the aforementioned wafer test data analysis method with respect to a plurality of stacked test wafers. Each test chip of the respective test wafer is defined with a coordinate point (X, Y) within the three-dimensional parameter location map, wherein the parameter is defined with respect to the accumulative count of failed test chips at the same coordinate point (X, Y), so that the data of the accumulative count of the failed test chips at the same coordinate point (X, Y) under the electrical property test regards as the respective coordinate point (Z).

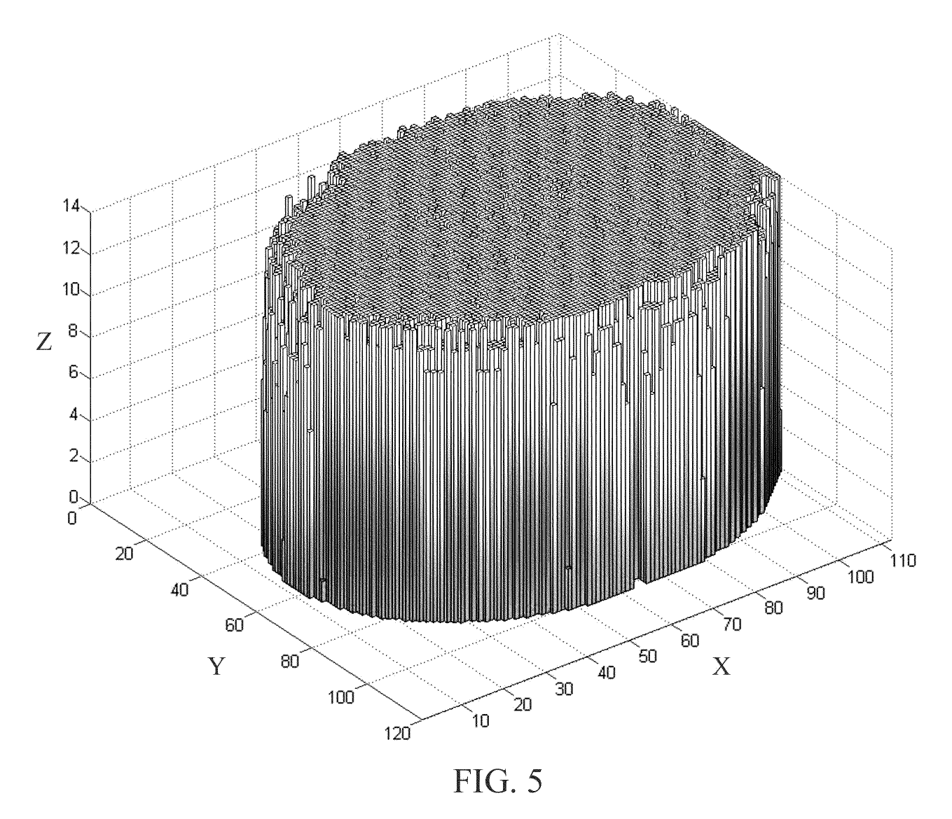

As shown in FIG. 5, the other three-dimensional parameter location map is generated by the aforementioned wafer test data analysis method with respect to a plurality of stacked test wafers. Each test chip of the respective test wafer is defined with a coordinate point (X, Y) within the three-dimensional parameter location map, wherein the parameter is defined with respect to the accumulative count of pass test chips at the same coordinate point (X, Y), so that the data of the accumulative count of the pass test chips at the same coordinate point (X, Y) under the electrical property test regards as the respective coordinate point (Z).

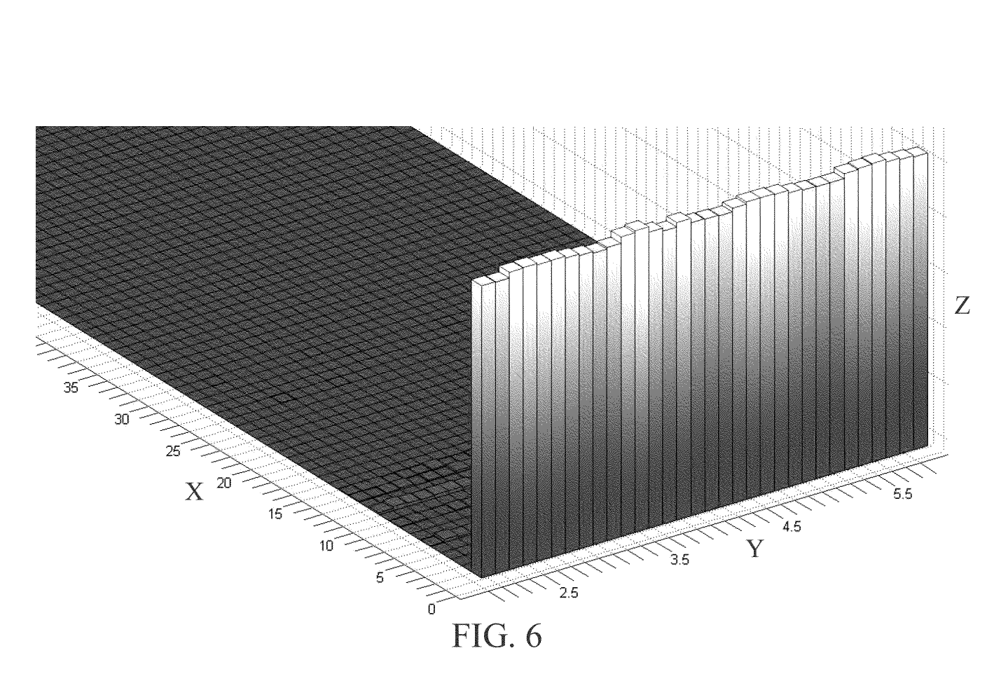

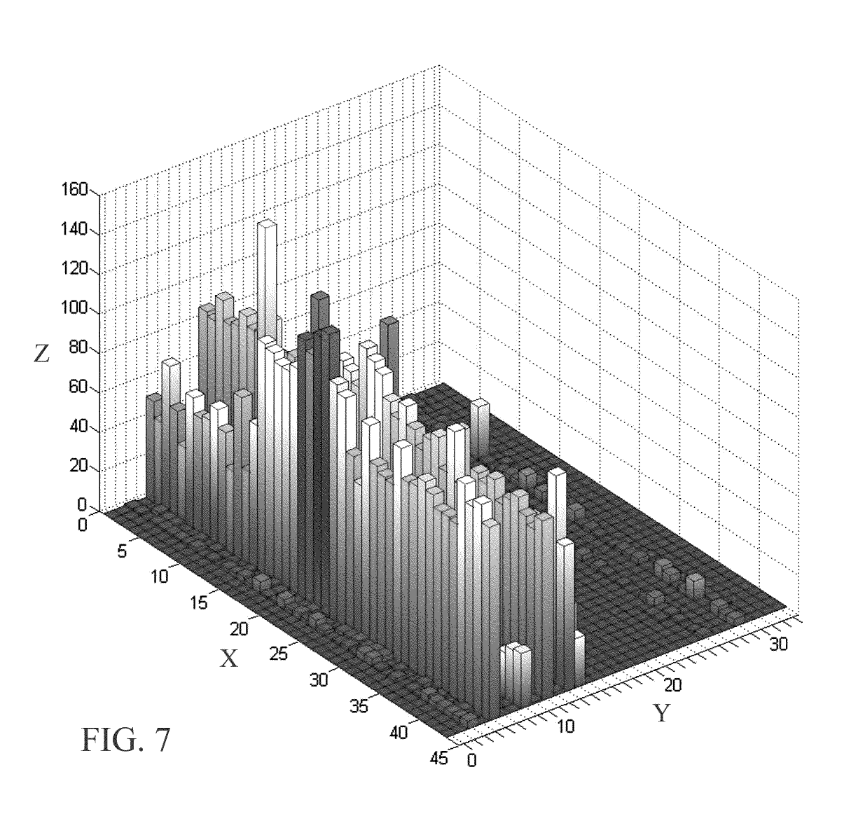

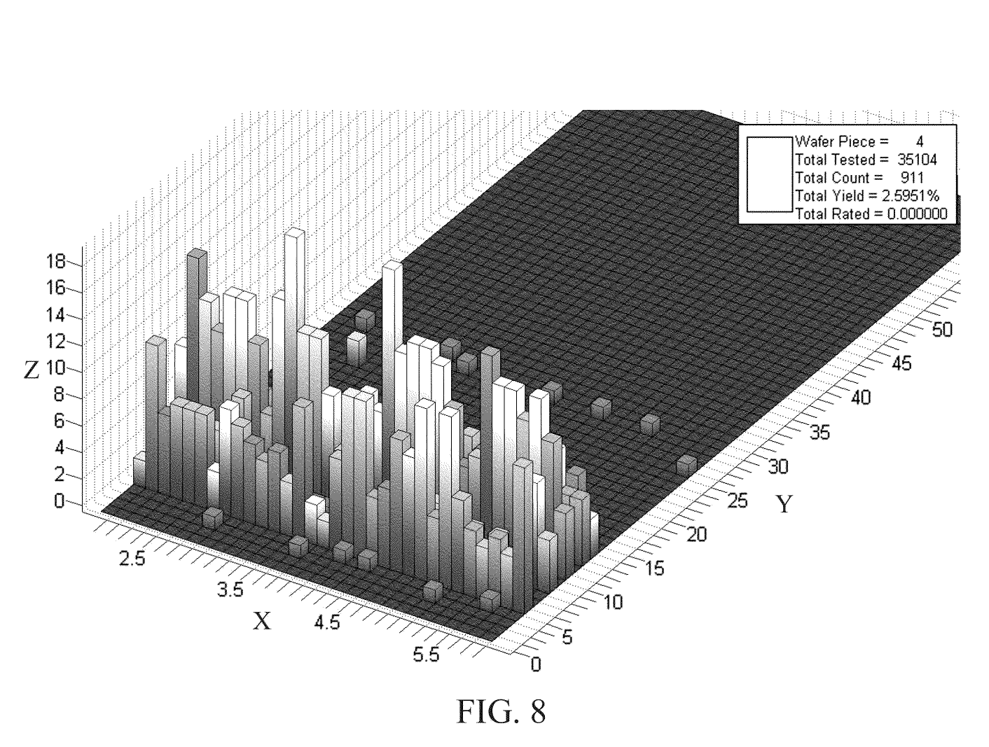

Furthermore, FIGS. 6-8 show another three-dimensional bin-bar map. In FIG. 6, the X-coordinate axis represents a specific grade (Binary); the Y-coordinate axis represents a plurality of wafers; and the Z-coordinate axis represents number. Accordingly, the three-dimensional bin-bar map shows the data distribution under the specific grade. As shown in FIG. 7, the X-coordinate axis represents a plurality of specific grades (Binary); the Y-coordinate axis represents a plurality of wafers; and the Z-coordinate axis represents number. Accordingly, the three-dimensional bin-bar map shows the data distribution under the specific grades. As shown in FIG. 8, the X-coordinate axis represents a plurality of specific grades (Binary); the Y-coordinate axis represents a plurality of wafers; and the Z-coordinate axis represents number. The difference between the three-dimensional bin-bar maps of FIG. 7 and FIG. 8 is that the test chips are classified into different groups according to the classification of test probes. In FIG. 8, the classification condition of the X-coordinate axis further sorts data of the test chips under a specific group.

The advantages of the present invention are described as following:

1. According to the aforementioned distribution map generated by the wafer test data analysis method for the data of test result, the accuracy of the data could be checked.

2. The aforementioned distribution map could be multi-batch drawn with respect to a plurality of wafers or single batch drawn with respect to single wafer.

3. The aforementioned distribution map could be calculated for median of standard deviation and variance of mean.

4. It is available to compare statistical parameters such as upper and lower limits of median and mean of standard deviation for quality control.

5. The trend of the test parameter could be observed.

6. According to the test results of the specific group of the test chips and comparing the statistical parameters of the test chip, the difference between every test chip could be observed.

7. Referring to FIGS. 6-8, the three-dimensional bin-bar map is drawn according to the classification condition, which can be set to one of the specific conditions or plurality of the classification conditions or all classification conditions. Therefore, the variations of the yield of the wafers could be compared easily. Also, the variations of the yield of test chips could be compared easily.

1. A wafer test data analysis method, comprising the steps of:
obtaining data: dividing a test wafer into a plurality of test chips, each of the test chips being tested for electrical property and captured data under various parameters;
sorting analyzing parameter: a specific parameter being sorted from the various parameters according to a requirement of an analysis result;
drawing three-dimensional parameter location map and three-dimensional bin-bar map: defining a three-dimensional space coordinate comprising an X-coordinate axis represented a first parameter, a Y-coordinate axis represented a second parameter, and a Z-coordinate axis represented a third parameter, the three-dimensional space coordinate having a plurality of coordinate points (X, Y, Z) to create a three-dimensional parameter location map and a three-dimensional bin-bar map.

2. The wafer test data analysis method as claimed in claim 1, wherein the three-dimensional space coordinate is transformed by a computer apparatus depending on positions of the test chips within the test wafer and the data of the specific parameter; wherein the X and Y-coordinate axes regard as an abscissa and the Z-coordinate axis as an ordinate; the abscissa defines a coordinate point (X, Y) of each test chip and the ordinate defines a coordinate point (Z) for the data of the specific parameter; and the test chips accord with the coordinate points (X, Y, Z) in the three-dimensional space coordinate to create the three-dimensional bin-bar map.

3. The wafer test data analysis method as claimed in claim 2, wherein the parameter is defined with respect to frequency from the electrical property test of each test chip.

4. The wafer test data analysis method as claimed in claim 2, wherein the parameter is defined with respect to electric current from the electrical property test of each test chip.

5. The wafer test data analysis method as claimed in claim 2, wherein the parameter is defined with respect to accumulative count of failed test chips of a plurality of stacked test wafers at same coordinate point (X, Y).

6. The wafer test data analysis method as claimed in claim 2, wherein the parameter is defined with respect to accumulative count of pass test chips of a plurality of stacked test wafers at same coordinate point (X, Y).

7. The wafer test data analysis method as claimed in claim 2, wherein the parameter is defined with respect to classification of test probes for the test chips.
